(19) United States
(12) Patent Application Publication
(10) Pub. No.: US 2009/0179615 A1
(43) Pub. Date: Jul. 16, 2009

(54) Universal battery charger

(75) Inventor: Alan Amron, Brooklyn, NY (US)

Correspondence Address: COHEN, PONTANI, LIEBERMAN & PAVANE LLP, 551 FIFTH AVENUE, SUITE 1210, NEW YORK, NY, 10176, US

(73) Assignee: GroFam-Amron

(21) Appl. No.: 12/008,507

(22) Filed: Jan. 11, 2008

(51) Int. Cl. H02J 7/02

(52) U.S. Cl. 320/114

(57) ABSTRACT

Presented is a device for charging a plurality of rechargeable batteries where each of the plurality of rechargeable batteries is disposed in a separate host electronic device during charging. The device includes a charging module, and a plurality of charging tips each in electrical communication with the charging module. Each of the plurality of charging tips is configured to electrically connect to a particular one of the separate host electronic devices and charge the one of the plurality of rechargeable batteries disposed therein. Charging parameters for each of the plurality of charging tips that are used for charging of the plurality of rechargeable batteries programmable by a user, determined by each of the plurality of charging tips, or determined by the charging module.

### BACKGROUND OF THE INVENTION

1. Field of the Invention

The present invention relates generally to battery chargers, and more particularly to a battery charger that is configured to charge one or more batteries of one or more types at the same time while the batteries are still disposed within their respective devices.

2. Description of the Related Art

Some existing battery chargers are capable of charging only one specific battery in a specific device. Other existing battery chargers are capable of charging several batteries of the same or different types, but the batteries must be taken out of their respective devices and inserted into the charger for charging. Still other existing battery chargers are capable of charging different battery types while the particular battery is still disposed in a device. However, these battery chargers can only charge one battery at a time and require selecting and connecting a particular charging tip to the charger depending on the device to be charged.

### SUMMARY OF THE INVENTION

In one aspect, the invention involves a device for charging a plurality of rechargeable batteries, where each of the plurality of rechargeable batteries is disposed in one of a plurality of separate host electronic devices during charging. The device includes a charging module, and a plurality of charging tips each in electrical communication with the charging module. Each of the plurality of charging tips is configured to electrically connect to a particular one of the plurality of separate host electronic devices and charge the one of the plurality of rechargeable batteries disposed therein. Charging parameters for each of the plurality of charging tips that are used for charging of the plurality of rechargeable batteries are programmable by a user, determined by each of the plurality of charging tips, or determined by the charging module.

In one embodiment, the charging module includes a plurality of charging circuits. Each of the charging circuits is in electrical communication with a particular one of the plurality of charging tips.

In another embodiment, each of the plurality of charging tips is configured to electrically connect to a different type of host electronic device.

In still another embodiment, each of the plurality of rechargeable batteries is charged at the same time.

In yet another embodiment, each of the plurality of rechargeable batteries is charged intermittently until each of the plurality of batteries is fully charged.

In other embodiments, each of the plurality of rechargeable batteries is a different battery type, or the same type

In another embodiment, the device further includes an AC adaptor in electrical communication with the charging module and is configured to connect to an AC power source and supply power to the charging module.

In still another embodiment, the device further includes an automobile 12V power supply adaptor in electrical communication with the charging module and is configured to connect to an automobile 12V power supply and supply power to the charging module.

In other embodiments, the device further includes a display, a keypad, a display, and keypad controller.

In another embodiment, each of the plurality of charging tips is removably connectable to the charging module.

In still another embodiment, the charging parameters for each of the plurality of charging tips are programmed by a user via the keypad.

In yet another embodiment, the charging parameters are determined by each of the plurality of charging tips by reading a voltage across each rechargeable battery's terminals and calculating the required charging current.

In still another embodiment, the charging parameters are determined by each of the plurality of charging tips by reading a required charging power from a charging circuit disposed in each of the plurality of host electronic devices.

In another embodiment, the charging parameters are determined by each of the plurality of charging tips by reading a required charging power from an RF tag associated with each of the plurality of host electronic devices.

In still another embodiment, each of the plurality of charging tips comprises an RC circuit for storing the charging parameters for the one of the host electronic devices that is electrically connected thereto.

In yet another embodiment, each of the plurality of charging tips comprises a memory for storing the charging parameters for the one of the host electronic devices that is electrically connected thereto.

In another aspect, the invention involves a method of charging a plurality of rechargeable batteries each disposed in a separate host electronic device. The method includes connecting each of the separate host electronic devices to a battery charger that includes a plurality of programmable charging tips, and supplying power to the battery charger.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, like reference characters refer to the same parts throughout the different views. Also, the drawings are not necessarily to scale, emphasis instead generally being placed upon illustrating the principles of the invention.

FIG. 1 is an illustrative block diagram of a universal battery charger including a plurality of charging tips, according to one embodiment of the invention.

FIG. 2 is an illustrative block diagram of a charging module of the universal battery charger of FIG. 1.

FIG. 3 is an illustrative schematic circuit diagram of charging module of the universal battery charger of FIG. 1.

FIG. 4A is an illustrative schematic circuit diagram of a charging tip including an RC circuit, according to one embodiment of the invention.

FIG. 4B is an illustrative schematic circuit diagram of a charging tip including a memory chip, according to one embodiment of the invention.

### DETAILED DESCRIPTION OF THE PREFERRED EMBODIMENTS

The present invention involves a battery charger that is configured to charge one or more batteries of one or more types at the same time while the batteries are still disposed within their respective host devices. For example, the disclosed battery charger is capable of charging electronic devices such as laptop computers, personal data assistants, cell phones, MP3 players, portable video games, digital cameras, video cameras, voice recorders, portable global positioning systems, or other portable electronic devices that include rechargeable batteries.

A user of the disclosed battery charger simply connects an appropriate charging tip corresponding to (configured to mate with) each particular device to be charged, and plugs the battery charger into a standard AC outlet (or automobile 12V supply). The disclosed battery charger supplies the appropriate charging current to each of the connected devices based on the particular charging tip used. Consequently, multiple portable devices can be charged at the same time regardless of the type of battery each host device contains, or the current required to charge a particular battery.

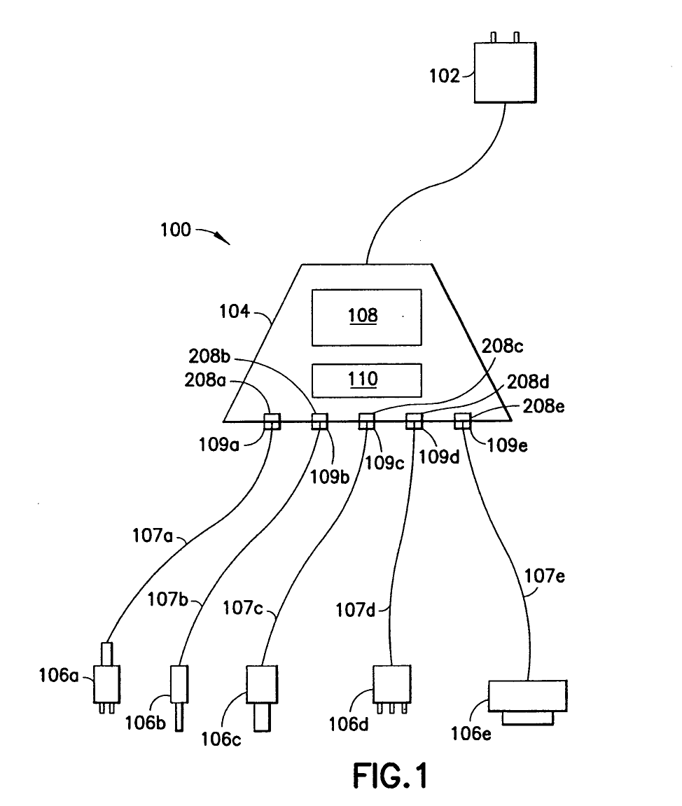

Referring to FIG. 1, in one embodiment, an illustrative block diagram of a universal battery charger 100 is shown. The battery charger 100 includes an AC adapter 102 in electrical communication (via AC power cable 101) with a charging module 104. The battery charger 100 also includes a LCD or LED display 108, a keypad 110, and one or more charging tips 106a, 106b, 106c, 106d, and 106e in electrical communication with the charging module 104 via wires 107a-e, respectively. In other embodiments, more or less charging tips can be included.

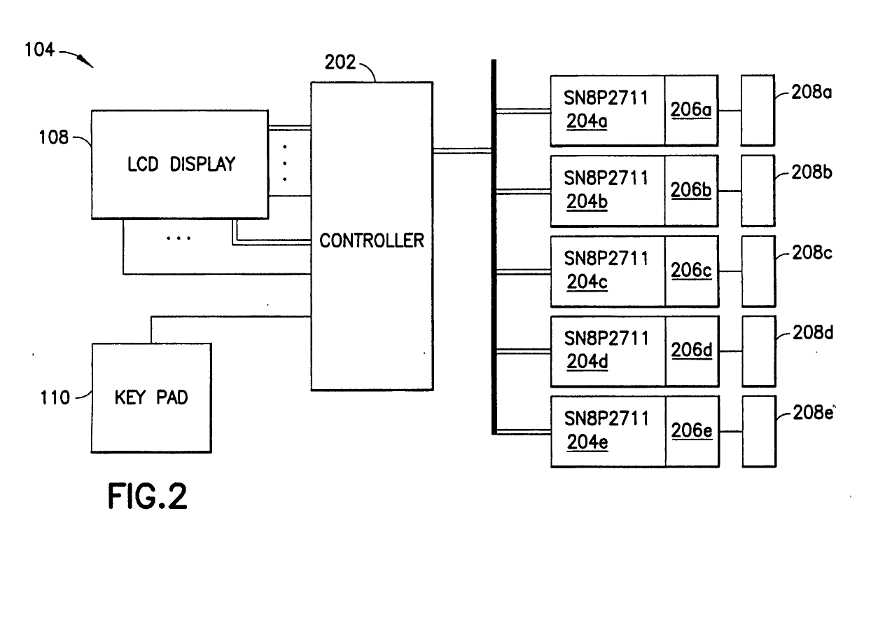

In one embodiment, the charging tips 106a, 106b, 106c, 106d, and 106e are permanently connected the charging module 104. In another embodiment, the charging tips 106a, 106b, 106c, 106d, and 106e include connectors 109a-e, respectively. Connectors 109a-e mate with charging tip connectors 208a-e disposed on the charging module 104 (see also FIG. 2). In this configuration, the charging tips 106a-e are detachable from the charging module 104, and can be replaced with other charging tips.

The charging tips 106a, 106b, 106c, 106d, and 106e include a variety of connectors that are configured to mate with standard electronic device charging ports. For example, charging tips 106a and 106b can be configured to mate with various standard cell phone charging ports, charging tips 106c and 106d can be configured to mate with various standard video camera, digital camera, GPS, PDA, and portable video game charging ports, and charging tip 106e can be configured to mate with standard laptop computer charging ports. Additional charging tips can be provided such that a charging tip is available to mate with any existing portable electronic device charging port.

In another embodiment, the AC adaptor 102 is detachable from the charging module 104 and replaceable with an automobile 12V power supply port (i.e., cigarette lighter port) adapter. In this embodiment, the automobile's battery supplies the charging current to charge the plurality of host electronic devices.

Referring to FIG. 2, in one embodiment, an illustrative block diagram of the electronic charging module 104 is shown. The charging module 104 includes display 108, keypad 110, controller 202, micro-controllers 204a-e, charging circuitry 206a-e, and charging tip connectors 208a-e.

The controller 202 is in electrical communication with the micro-controllers 204a-e, the keypad 110, and the display 108. Each micro-controller 204a-e is in electrical communication with, and controls, the charging circuitry 206a-e, respectively. The charging circuitry 206a-e is in electrical communication with the connectors 208a-e, respectively. The connectors 208a-e facilitate connection of the charging tips 106a-e, to the charging circuitry 206a-e, respectively. In other embodiments, if more charging tips are included, then additional micro-controllers, charging circuitry, and charging tip connectors are also included in the charging module 104.

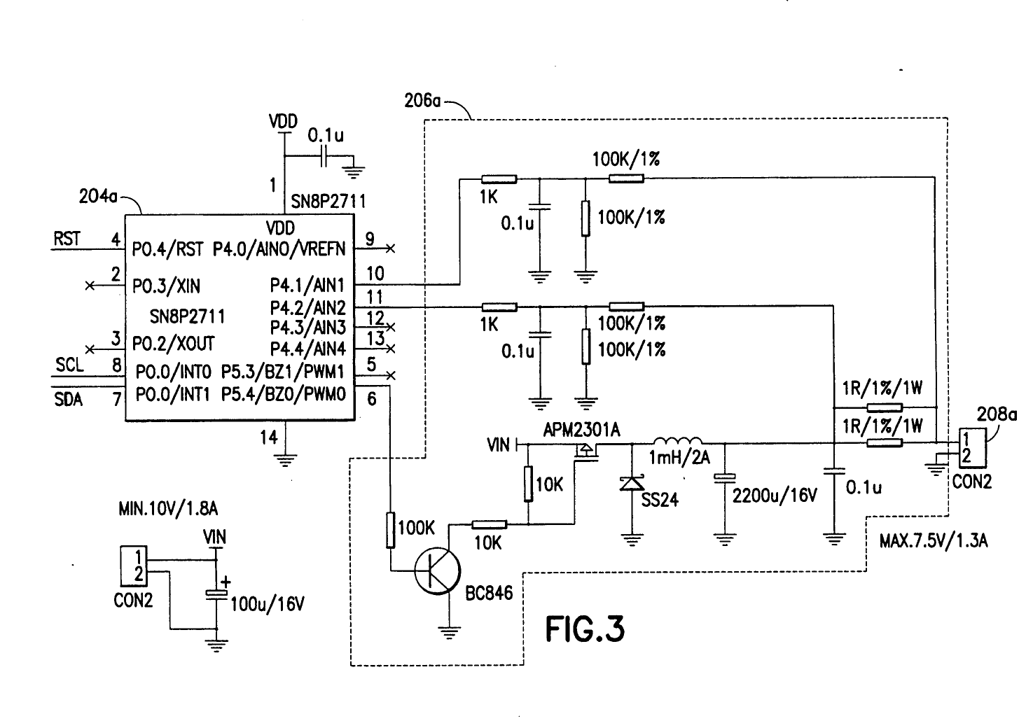

FIG. 3 is a detailed schematic diagram of one embodiment of charging circuitry 206a and the connections to the micro-controller 204a and connector 208a. The particular values for the various components used in the charging circuitry 206a-e will vary depending on the particular charging tips to be connected and the rechargeable battery to be charged. In other words, charging circuitry 206a, if used to charge cell phones will be different from charging circuitry 206e, which might be used to charge laptop computers. The various possible configurations of the charging circuitry 205a-e involve simple charging circuit design choices known to those skilled in the art. In one embodiment, the charging circuitry supplies a maximum of 1.5 amps and 7.5 volts.

In one embodiment, the battery charger 100 charges the batteries disposed in the connected host devices at the same time. In another embodiment, the battery charger 100 charges each battery in each connected device intermittently until each of the rechargeable batteries is fully charged. In this embodiment, the battery of a first connected host device is supplied a charging current for a predetermined period of time, and then the charging current is stopped. Then, the battery in the next connected host device is supplied a charging current for the predetermined period of time, and then the charging current is stopped. This charging sequence continues until all the batteries in the connected host devices receive a charging current. Thereafter, the charging sequence repeats until each of the rechargeable batteries is fully charged. This embodiment is used if all of the batteries in the connected host devices draw a combined current that exceeds the maximum current supplied by the charging module 104.

In still another embodiment, if the battery in a particular host device draws more current than the charging circuitry 206a-e is configured to provide, the micro-controller 204a-e stops charging the connected host device and displays an error message on the display 108.

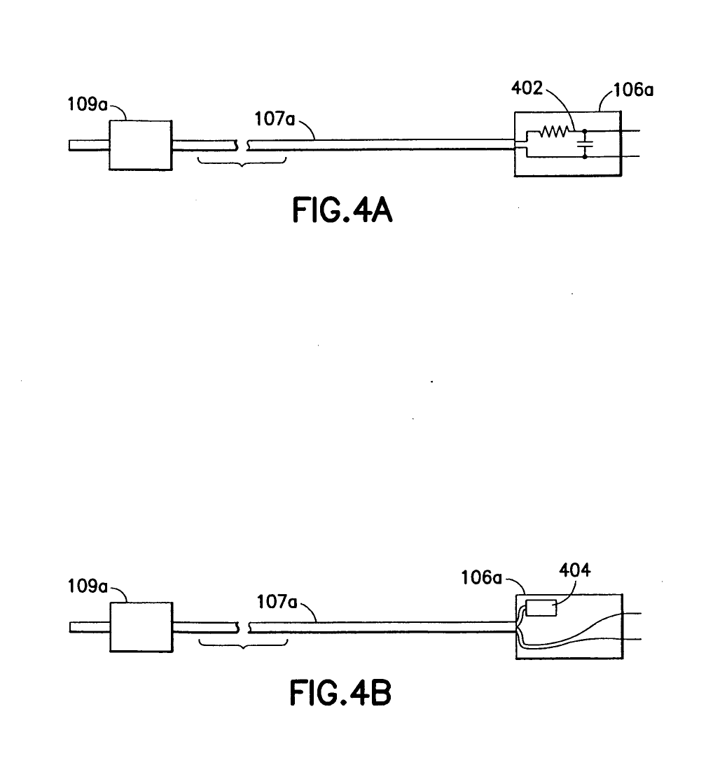

Referring to FIG. 4A, in one embodiment, the particular charging parameters (i.e., current and voltage) required by a particular battery in a particular device is automatically determined by the particular charging tip 106a-e used. In this embodiment, each charging tip (e.g., 106a-e) includes a particular RC (resistor-capacitor) circuit 402 that corresponds to the host electronic device that connects to the charging tip (e.g., 106a-e). In other words, when a particular charging tip is connected to the charging module 104, the connected charging circuitry determines from the RC circuit 402 the particular current and voltage to be supplied to the battery in the connected host device.

Alternatively, and referring to FIG. 4B, each charging tip (generally 106) can include a memory 404 (instead of the RC circuit 402) that stores current and voltage information. When a particular charging tip 106a-e is connected to particular connector 208a-e, the corresponding charging circuitry 206a-e provides power to the memory 404 and reads from the memory in the charging tip 106a-e the current and voltage required to charge the host device that mates with the particular charging tip 106a-e.

In still another embodiment, each connector 109a-e of each charging tip 106a-e includes a unique pin configuration that, when connected to the respective connector 109a-e in the charging module 104, determines the current and voltage to be supplied to the particular batteries in the host devices connected to the charging tips 106a-e.

In another embodiment, the particular current required by a particular battery in a particular device is set (i.e., programmed) by the user via the keypad 110. In this embodiment, the user obtains the voltage and current requirements from a particular host electronic device's specification (typically included in the device's user manual), and programs the charging voltage/current for the particular charging tip 106a-e and host device via the keypad 110 and display 108. The current and voltage for a particular charging tip 106a-e (which mates with a particular host device) is stored in the associated micro-controller 204a-e or other memory. Each micro-controller 204a-e (or associated memory) is capable of storing one or more current/voltage profiles that are associated with different charging tips. After a particular current and voltage have been programmed and saved by the user, the user only needs to connect the appropriate charging tip 106a-e to the charging module 104 (via connectors 208a-e) to retrieve the current/voltage profile associated with the particular charging tip 106a-e.

In other embodiments, the particular current required by a particular battery in a particular device is determined by reading the voltage across the battery terminals (via the connected charging tip) and calculating the required charging current; or reading (via the connected charging tip) the required charging power from a charging circuit disposed in the particular device being charged.

In still another embodiment, the particular current required by a particular battery in a particular device is determined by reading the required charging power from the particular device's RF tag. In this embodiment, it is assumed that each host device includes an RF tag that includes charging current and voltage information for the battery included in the host device. Further, in this embodiment, the charging module 104 includes an RF reader that is configured to read the current and voltage information of the connected host device and provide the information to the micro-controller 204a-e and charging circuitry 206a-e associated with the particular charging tip 106a-e an connected host device.

In another embodiment, the particular current required by a particular battery in a particular device is determined by charging the particular batter 1 volt at a time until the battery is fully charged (i.e., until the battery output voltage no longer increases).

Variations, modifications, and other implementations of what is described herein may occur to those of ordinary skill in the art without departing from the spirit and scope of the disclosed subject matter. Accordingly, the disclosed subject matter is not to be defined only by the preceding illustrative description.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A device for charging a plurality of rechargeable batteries, each of the plurality of rechargeable batteries being disposed in one of a plurality of separate host electronic devices during charging, the device comprising:
a charging module; and
a plurality of charging tips each in electrical communication with the charging module, each of the plurality of charging tips being configured to electrically connect to a particular one of the plurality of separate host electronic devices and charge the one of the plurality of rechargeable batteries disposed therein;
wherein the charging module is configured to output variable charging parameters, whereby charging different ones of the plurality of rechargeable batteries having different charging parameters is facilitated,
the charging parameters for each of the plurality of charging tips that are used for charging of the plurality of rechargeable batteries being one of programmable by a user, determined by each of the plurality of charging tips, or determined by the charging module.

2. The device according to claim 1, wherein the charging module comprises a plurality of charging circuits, each of the charging circuits being in electrical communication with a particular one of the plurality of charging tips.

3. The device according to claim 1, wherein each of the plurality of charging tips is configured to electrically connect to a different type of host electronic device.

4. The device according to claim 1, wherein the charging module is configured to simultaneously charge each of the plurality of rechargeable batteries connected to the charging module.

5. The device according to claim 1, wherein the charging module is configured to intermittently charge each of the plurality of rechargeable batteries each of the plurality of batteries connected to the charging module until each of the plurality of batteries is fully charged.

6. The device according to claim 1, wherein each of the plurality of rechargeable batteries is a different battery type.

7. The device according to claim 1, wherein each of the plurality of rechargeable batteries is the same battery type.

8. The device according to claim 1 further comprising an AC adaptor in electrical communication with the charging module and being configured to connect to an AC power source and supply power to the charging module.

9. The device according to claim 1 further comprising an automobile 12V power supply adaptor in electrical communication with the charging module and being configured to connect to an automobile 12V power supply and supply power to the charging module.

10. The device according to claim 1 further comprising a display and a keypad.

11. The device according to claim 1, wherein the module further comprises a display and keypad controller.

12. The device according to claim 1, wherein each of the plurality of charging tips is removably connectable to the charging module.

13. The device according to claim 10, wherein the charging parameters for each of the plurality of charging tips are programmed by a user via the keypad.

14. The device according to claim 1, wherein the charging parameters are determined by each of the plurality of charging tips by reading a voltage across each rechargeable battery's terminals and calculating the required charging current.

15. The device according to claim 1, wherein the charging parameters are determined by each of the plurality of charging tips by reading a required charging power from a charging circuit disposed in each of the plurality of host electronic devices.

16. The device according to claim 1, wherein the charging parameters are determined by each of the plurality of charging tips by reading a required charging power from an RF tag associated with each of the plurality of host electronic devices.

17. The device according to claim 1, wherein each of the plurality of charging tips comprises an RC circuit for storing the charging parameters for the one of the host electronic devices that is electrically connected thereto.

18. The device according to claim 1, wherein each of the plurality of charging tips comprises a memory for storing the charging parameters for the one of the host electronic devices that is electrically connected thereto.

19. A method of charging a plurality of rechargeable batteries each disposed in a separate host electronic device, the method comprising:
connecting each of the separate host electronic devices to a battery charger as claimed in claim 1; and
supplying power to the battery charger.
